(19) United States
(12) Patent Application Publication
(10) Pub. No.: US 2008/0013127 A1
(43) Pub. Date: Jan. 17, 2008

(54) IMAGE FORMING APPARATUS AND METHOD FOR SWITCHING DISCHARGE TRAY

(76) Inventors: Yasunobu OHKAWA, Nara (JP); Jinichi Nagata, Osaka (JP); Yasuhiro Takai, Nara (JP)

Correspondence Address: Mark D. Saralino, Esq.;19th Floor, Renner, Otto, Boisselle & Sklar, LLP., 1621 Euclid Ave., Cleveland, OH, 44115, US

(21) Appl. No.: 11/774,644

(22) Filed: Jul. 9, 2007

(30) Foreign Application Priority Data
Jul. 12, 2006 (JP) 2006-191797

(51) Int. Cl. H04N 1/21

(52) U.S. Cl. 358/296

(57) ABSTRACT

In one embodiment, a discharge distribution setting portion sets which of a first discharge tray and a second discharge tray that recording paper will be discharged to, and how many sheets of recording paper to distribute, based on an input (instruction) to an operating display portion. More specifically, the discharge distribution setting portion has a function to, by setting a distribution division for a number of sheets of recording paper discharged in response to a print request (number of discharged sheets), distribute recording paper to the discharge trays (the first discharge tray and the second discharge tray) based on a number of sheets to distribute that has been assigned in advance to a discharge distribution destination.

### CROSS REFERENCE TO RELATED APPLICATIONS

This application claims priority under 35 U.S.C. § 119(a) on Japanese Patent Application No. 2006-191797 filed in Japan on Jul. 12, 2006, the entire contents of which are hereby incorporated by reference.

### BACKGROUND OF THE INVENTION

1. Field of the Invention

The present invention relates to an image forming apparatus provided with a plurality of discharge trays and a method for switching the discharge tray in such an image forming apparatus.

2. Related Art

In recent image forming apparatuses, an acceleration of printing speed in comparison to conventional image forming apparatuses has been sought. In an image forming apparatus in which printing speed has been accelerated, the acceleration is accompanied by a greater number of sheets of print processing, and there may be cases in which a request is made for printing of a large number of sheets in a single print job.

Accordingly, in an image forming apparatus in which printing speed has been accelerated, in order to not stop a print job that is in progress, a plurality of paper feed trays and a large capacity paper feed cassette (LCC: Large Capacity Cassette) are disposed in a paper feed portion.

On the other hand, in a discharge storage portion, only a discharge tray for storing recording paper that has been printed is disposed, and so even when there is a request for printing of a large number of sheets, the discharge disposition destination (the discharge tray) is limited. In other words, it is possible that recording paper is removed so as to impair characteristics having been considered when producing the image forming apparatus, such as improvement in the stackability of recording paper that has been discharged, a shifter function provided as a function of the image forming apparatus, or the like.

An example of a conventional high speed image forming apparatus is capable of, for example, performing print processing at about 60 sheets per minute, but an example of a recent high speed image forming apparatus is capable of, for example, performing print processing at about 100 sheets per minute. Accordingly, when high volume print processing is performed, the number of sheets of recording paper discharged to the discharge tray is also large, and in this state it is difficult to smoothly remove recording paper from the discharge tray.

More specifically, when a user attempts to remove recording paper that has been discharged and stored in a large quantity in the discharge storage portion (the discharge tray), in a state in which, for example, about 1000 sheets of the recording paper have been stored, it is difficult to precisely and swiftly remove the recording paper that has been discharged.

For example, in the case of a high speed apparatus provided with two discharge trays (a first discharge tray and a second discharge tray) having a storage capacity of 1000 sheets, when print processing of 2500 sheets is performed, after 1000 sheets have been discharged to the first discharge tray and that tray becomes full, 1000 sheets are then discharged to the second discharge tray (for example, see JP 2001-171887A). In a state in which recording paper is discharged to the second discharge tray, it is necessary to remove the recording paper that has been discharged to the first discharge tray, but even when an attempt is made to remove recording paper from the first discharge tray, 1000 sheets of recording paper are heavy and voluminous, so it is difficult for that paper to be easily removed.

That is, in a state in which 1000 sheets have been discharged to the second discharge tray and so that tray is full, it becomes necessary to temporarily halt the discharge (i.e., print processing) of recording paper, and thus effective high speed printing cannot be performed. Also, as described above, it is difficult to remove recording paper from the first discharge tray and the second discharge when they are full.

Accordingly, with acceleration of the image forming apparatus, it becomes necessary to improve or modify peripheral functions such as a discharge function (ease of removing recording paper) in addition to the paper feed function.

### SUMMARY OF THE INVENTION

It is an object of the present invention to provide an image forming apparatus with which it is possible to smoothly and easily remove recording paper that has been discharged to a discharge tray, and a method for switching the discharge tray.

The image forming apparatus according to the invention is provided with a discharge unit that has a plurality of discharge trays including a first discharge tray and a second discharge tray as discharge distribution destinations, and that discharges printed recording paper to the discharge trays; and according to distribution division settings for the recording paper that is discharged respectively to the first discharge tray and the second discharge tray, the discharge destination is switched from the first discharge tray to the second discharge tray at a number of distributed sheets of recording paper discharged to the first discharge tray that is less than the storage capacity of the first discharge tray.

With this configuration, it is possible to discharge recording paper to be discharged in response to a print request (the number of sheets in the print request) to each discharge tray based on a distribution division that has been assigned in advance to a discharge distribution destination. Therefore, it becomes possible to adjust (set, select) recording paper to be discharged in a large quantity to each discharge tray to a number of distributed sheets that a user can easily process, and thus it becomes possible to smoothly remove recording paper that has been stored in a discharge tray by fast and high volume print processing.

Also, in the image forming apparatus according to the invention, a discharge distribution setting portion for setting the distribution division may be further provided.

With this configuration, it is possible to easily set the number of distributed sheets corresponding to the discharge distribution destination.

Also, in the image forming apparatus according to the invention, the distribution division may be set based on a number of discharge sheets.

With this configuration, it is possible to set the discharge distribution destination (the first discharge tray and the second discharge tray) and the number of distributed sheets, and to switch the discharge destination, according to the number of discharged sheets.

Also, in the image forming apparatus according to the invention, the distribution division may be set based on a number of discharged sets.

With this configuration, it is possible to set the discharge distribution destination (the first discharge tray and the second discharge tray) and the number of distributed sheets, and to switch the discharge destination, according to the number of discharged sets.

Also, in the image forming apparatus according to the invention, the distribution division may be set based on a job.

With this configuration, it is possible to set the discharge distribution destination (the first discharge tray and the second discharge tray) and the number of distributed sheets, and to switch the discharge destination, according to the job.

Also, in the image forming apparatus according to the invention, the distribution division may be set based on a processing function mode.

With this configuration, it is possible to set the discharge distribution destination (the first discharge tray and the second discharge tray) and the number of distributed sheets, and to switch the discharge destination, according to the processing function mode.

Also, in the image forming apparatus according to the invention, a configuration may be adopted in which when discharge of recording paper to the first discharge tray used as a prior discharge destination ends and then the discharge destination is switched to the second discharge tray used as a subsequent discharge destination, a removal request notification signal is generated to cause the recording paper discharged to the first discharge tray to be removed to outside.

With this configuration, it is possible to reliably remove recording paper that has been discharged to the first discharge tray when recording paper is being discharged to the second discharge tray, so that without interruption, it is possible to continuously discharge recording paper also to the first discharge tray after discharge of recording paper to the second discharge tray.

Also, in the image forming apparatus according to the invention, a configuration may be adopted in which when discharge of recording paper to the second discharge tray used as a prior discharge destination ends and then the discharge destination is switched to the first discharge tray used as a subsequent discharge destination, a removal request notification signal is generated to cause the recording paper discharged to the second discharge tray to be removed to outside.

With this configuration, it is possible to reliably remove recording paper that has been discharged to the second discharge tray when recording paper is being discharged to the first discharge tray, so that without interruption, it is possible to continuously discharge recording paper also to the second discharge tray after discharge of recording paper to the first discharge tray.

Also, in the image forming apparatus according to the invention, a configuration may be adopted in which a first removal detector that detects removal of recording paper that has been discharged to the first discharge tray, and a second removal detector that detects removal of recording paper that has been discharged to the second discharge tray, are further provided, and when removal of recording paper from the first discharge tray has been detected, subsequent discharge of recording paper to the first discharge tray continues, and when removal of recording paper from the second discharge tray has been detected, subsequent discharge of recording paper to the second discharge tray continues.

With this configuration, subsequent discharge of recording paper is continued after confirming removal of recording paper from each discharge tray, so discharge jams can be reliably prevented.

Also, in the image forming apparatus according to the invention, a configuration may be adopted in which when removal of recording paper from the first discharge tray or the second discharge tray is not detected, subsequent print processing is stopped.

With this configuration, subsequent print processing is stopped when removal of recording paper from each discharge tray cannot be confirmed, so discharge jams can be reliably prevented.

The method for switching the discharge tray according to the invention is a method for switching a discharge tray in an image forming apparatus that has a plurality of discharge trays including a first discharge tray and a second discharge tray as discharge distribution destinations, and that discharges printed recording paper to the discharge trays, and the method includes setting a distribution division of recording paper to be discharged respectively to the first discharge tray and the second discharge tray, and according to the distribution division that has been set, switching the discharge destination from the first discharge tray to the second discharge tray at a number of distributed sheets of recording paper discharged to the first discharge tray that is less than the storage capacity of the first discharge tray.

With this configuration, it is possible to discharge a desired number of sheets of recording paper to each discharge tray and to switch the discharge tray even in the case of high volume printing, so the number of distributed sheets can be adjusted to a range that is easily processed by a user.

As described above, with the image forming apparatus and the method for switching a discharge tray according to the invention, an effect is attained that it is possible to set a distribution division for recording paper to be discharged in response to a print request and assign to each discharge tray a number of distributed sheets that is less than the storage capacity of the discharge tray, so it becomes possible to adjust the recording paper to be discharged in a large quantity to the discharge trays to a number of distributed sheets that a user can easily process, and thus it becomes possible to smoothly remove recording paper that has been stored in a discharge tray by fast and high volume print processing.

### BRIEF DESCRIPTION OF THE DRAWINGS

FIG. 1 is a side view that shows the general configuration of an image forming apparatus according to an embodiment of the invention.

FIGS. 2A and 2B are side views that show the general configuration of a discharge unit of the image forming apparatus according to the embodiment of the invention; FIG. 2A shows a case of discharging to a first discharge tray, and FIG. 2B shows a case of discharging to a second discharge tray.

FIG. 3 is a block diagram that shows the general configuration of a function control block of the image forming apparatus according to the embodiment of the invention.

FIG. 4 is a flowchart (part 1) that shows an example of the flow of processing in the image forming apparatus according to the embodiment of the invention.

FIG. 5 is a flowchart (part 2) that shows an example of the flow of processing in the image forming apparatus according to the embodiment of the invention.

### DESCRIPTION OF THE PREFERRED EMBODIMENTS

Hereinafter, embodiments of the present invention will be described in detail with reference to the accompanying drawings.

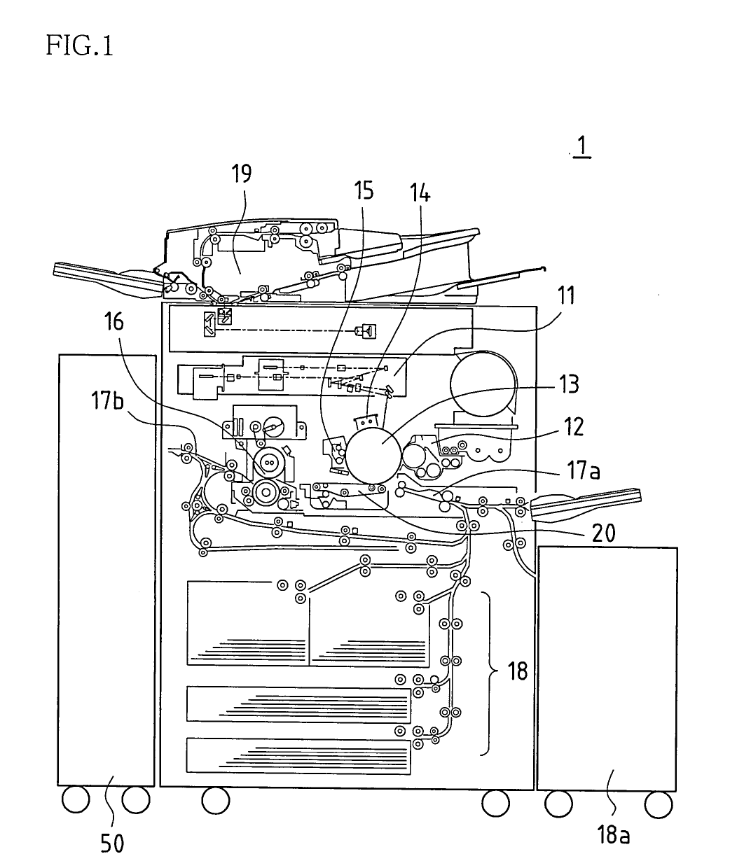

FIG. 1 is a side view that shows the general configuration of an image forming apparatus according to an embodiment of the invention.

An image forming apparatus 1 according to this embodiment is configured, for example, to form a monochrome image on a predetermined sheet (recording paper) corresponding to image data acquired from outside. Below, “image forming” may also be referred to as “printing”.

The image forming apparatus 1 is configured from an image forming mechanism portion (including an exposing unit 11, a development unit 12, a photosensitive body 13, a charging unit 14, a cleaner unit 15, a fixing unit 16, and the like) that performs a process of image forming onto recording paper, a paper feed cassette 18 that feeds recording paper to the image forming mechanism portion via a paper feed transport path 17a, and a discharge unit 50 that discharges recording paper for which print processing has ended via a paper discharge transport path 17b. When it is not necessary to distinguish between the paper feed transport path 17a and the paper discharge transport path 17b, they are referred to simply as the paper transport path.

The paper feed cassette 18 is trays for feeding sheets (recording paper) used for image forming, and is configured as a plurality of trays capable of storing 500 to 1500 sheet of recording paper of a fixed size. Also, the image forming apparatus 1 is configured to be capable of high speed printing, so in addition to the paper feed cassette 18 used as a paper feed portion, a large capacity paper feed cassette (referred to below as an LCC) 18a is externally attached. The LCC 18a is capable of feeding, for example, 6000 to 7000 sheets of paper. With this configuration, it is possible to prevent the occurrence of inadequate paper feeding even in the case of high speed printing, and so the apparatus can be allowed to effectively exhibit a high speed printing function.

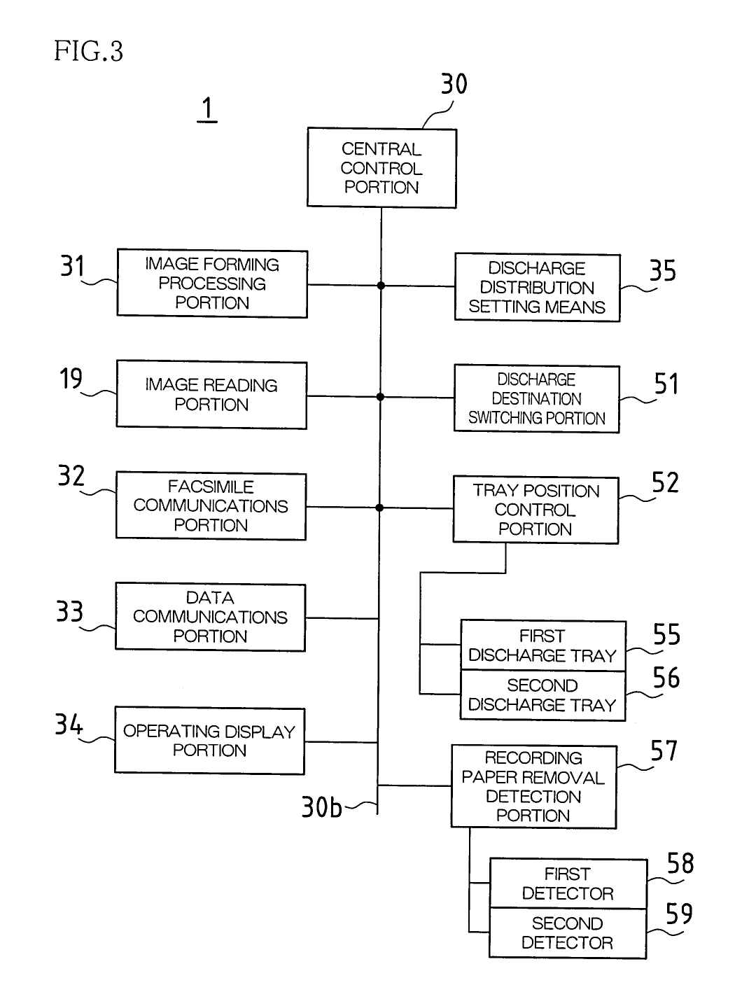

Also, the image forming apparatus 1 is provided with an image reading portion 19 as a mechanism that acquires image data from outside. The image reading portion 19 is provided with an auto sheet feeder (ASF) that enables the image forming apparatus 1 to perform high speed reading, and is configured to be compatible with high speed printing. Image data can also be acquired by a means other than the image reading portion 19; for example it is preferable to adopt a configuration in which image data is acquired by a facsimile communications portion 32 (see FIG. 3), or by a data communications portion 33 (see FIG. 3).

A processing function mode is changed according to these forms of image data acquisition (acquisition method or print request). For example, it is preferable to adopt a configuration provided with processing function modes that process print requests corresponding to a function as a copy machine (copier function), a function as a printing machine (a printer function), and also a function as a phototelegraphic machine (a facsimile function).

The charging unit 14 is a charging means for uniformly charging the surface of the photosensitive body 13 (photosensitive drum) to a predetermined potential, and is a charger-type charging unit. Other than a charger-type charging unit, a contact-type (roller-type or brush-type) charging unit can also be used.

The exposing unit 11 is configured using a laser scanning unit (LSU) provided with a laser irradiation portion and reflecting mirrors. It is also possible to use a write head in which, for example, light emitting elements such as ELs or LEDs are aligned in an array. Also, the exposing unit 11 (image forming apparatus 1) is configured by adopting a two-beam image forming technique using a plurality of laser beams, and due to achieving an acceleration of the irradiation timing, the exposing unit 11 is capable of high speed print processing.

Laser beams corresponding to the image data are emitted from the laser irradiation portion, and irradiated (input) to the photosensitive body 13, which has been uniformly charged by the charging unit 14. Accordingly, the surface of the photosensitive body 13 is exposed by the laser beams corresponding to the input image data, forming an electrostatic latent image corresponding to the image data on the surface of the photosensitive body 13.

The development unit 12 develops the electrostatic latent image formed on the surface of the photosensitive body 13 with black toner. Also, the cleaner unit 15 removes and recovers toner remaining on the surface of the photosensitive body 13 after development and image transfer.

The electrostatic image developed on the photosensitive body 13 is transferred onto recording paper that has been transported from the transfer mechanism 20 (for example, a transfer belt unit), by application of an electrical field to the recording paper with a polarity opposite to that of the electrical charge possessed by the electrostatic image. For example, when the electrostatic image has a charge with negative polarity, the applied polarity of the transfer mechanism 20 is positive.

In the transfer mechanism 20, a transfer belt having a predetermined resistance value (in a range of 1×10⁹ to 1×10¹³ Ω·cm) is disposed in a state bridging a drive roller, an idler roller, and other rollers, and in a contact portion of the photosensitive body 13 and the transfer belt, an elastic electrically conductive roller is disposed that can apply a transfer electrical field with a different electrical conductivity than that of the drive roller and the idler roller. By using the elastic electrically conductive roller as the contact portion, the photosensitive body 13 and the transfer belt make surface contact with a predetermined width (called a transfer nip), not linear contact. More specifically, due to the photosensitive body 13 and the transfer belt making surface contact, it is possible to achieve an improvement in the efficiency of transfer to the transported recording paper.

Downstream from the transfer region of the transfer belt, a charge removal roller is disposed on the back side of the transfer belt in order to remove the electrical field that was applied in the transfer region from the recording paper that has been transported, and smoothly transport the recording paper to the next stage. Also, a cleaning unit that removes toner stains from the transfer belt, and a charge removal mechanism that removes electrical charges from the transfer belt, are disposed in the transfer mechanism 20.

The electrostatic image (unfixed toner) transferred onto recording paper with the transfer mechanism 20 is transported to the fixing unit 16. The fixing unit 16 is provided with a hot roller and a pressure roller, and the inner circumferential portion of the hot roller has a heat source that keeps the surface of the hot roller at a predetermined temperature (fixing set temperature: generally 160 to 200° C.). Also, a pressure member that presses the pressure roller against the hot roller with a predetermined pressure is disposed at both ends of the pressure roller.

Heat and pressure are applied to recording paper transported to the pressing portion (called a fixing nip portion). Accordingly, the unfixed toner on the recording paper is melted at the surface temperature of the hot roller, and fixed on the recording paper by a throw-tacking action provided by the pressing force of the pressure roller.

In the image forming apparatus 1, the discharge unit 50 used as a discharge storage portion is disposed adjacent to the paper discharge transport path 17b in order to further make use of the high speed printing function. The discharge unit 50, in consideration of the ease to remove discharged paper, is disposed on the side face of the side opposite to the LCC 18a.

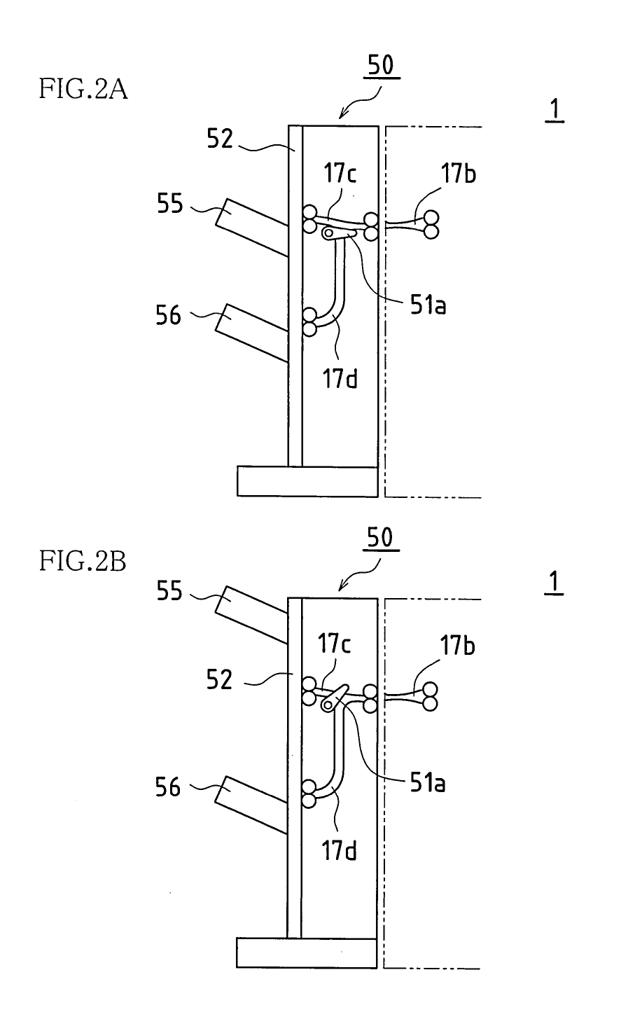

FIGS. 2A and 2B are side views that show the general configuration of a discharge unit of the image forming apparatus according to the embodiment of the invention; FIG. 2A shows a case of discharging to a first discharge tray, and FIG. 2B shows a case of discharging to a second discharge tray.

The discharge unit 50, which constitutes a portion of the image forming apparatus 1 according to this embodiment, is provided with a first discharge tray 55 and a second discharge tray 56 (referred to simply as the discharge tray when it is not necessary to distinguish between the first discharge tray 55 and the second discharge tray 56) as discharge distribution destinations (also referred to as discharge destinations), and is configured to discharge recording paper transported from the paper discharge transport path 17b to either of the first discharge tray 55 and the second discharge tray 56. A case is described in which there are at least two discharge trays, but it is also possible to further increase the number of discharge trays.

By switching the discharge tray used as the discharge distribution destination (the first discharge tray 55 and the second discharge tray 56) with a discharge destination switching claw 51a, recording paper transported from the paper discharge transport path 17b is discharged to the first discharge tray 55 when a first discharge transport path 17c has been selected (see FIG. 2A), and discharged to the second discharge tray 56 when a second discharge transport path 17d has been selected (see FIG. 2B). The discharge destination switching claw 51a is controlled by a discharge destination switching portion 51 (see FIG. 3).

The positions of the first discharge tray 55 and the second discharge tray 56 are appropriately adjusted by a tray position control portion 52, and when, for example, recording paper is being discharged to the second discharge tray 56, the first discharge tray 55 can be moved upward. Because the first discharge tray 55 moves upward, recording paper discharged to the second discharge tray 56 can be easily and quickly removed by using an enlarged space. Also note that the positions of the first discharge tray 55 and the second discharge tray 56 can be appropriately synchronized with the discharge state by the tray position control portion 52.

The first discharge tray 55 and the second discharge tray 56, for example, have a storage capacity to store 2000 sheets each, and 4000 sheets total, of discharged recording paper, and thus have specifications that are compatible with high speed printing. That is, the first discharge tray 55 and the second discharge tray 56 are configured to be capable of continuously discharging recording paper without stopping a print job, due to having a large storage capacity.

A configuration is adopted such that recording paper that has been printed is ordinarily discharged to the first discharge tray 55, and then discharged to the second discharge tray 56. In the image forming apparatus 1 according to this embodiment, distribution divisions are set for the recording paper discharged to each of the first discharge tray 55 and the second discharge tray 56 (assignment of a number of sheets distributed to each discharge distribution destination).

More specifically, a configuration is adopted in which by setting the number of sheets distributed to each discharge distribution destination, for example, at a number of sheets distributed that is less than the storage capacity of the first discharge tray 55 that has been set as the prior discharge distribution destination (that is, before that discharge tray becomes full), the discharge distribution destination is switched so that the second discharge tray 56 is set as the next discharge distribution destination. Also note that the distribution divisions can be similarly set when there are three or more discharge trays.

With this configuration, it is possible to distribute (discharge) a designated number of distributed sheets of recording paper to a designated discharge tray corresponding to a number of distributed sheets obtained by distributing to a discharge distribution destination in advance a number of discharged sheets corresponding to a print request (the number of sheets in the print request). Accordingly, it is possible to adjust (set, select) recording paper to be discharged in a large quantity to a discharge tray to a number of distributed sheets that a user can easily process, and thus it becomes possible to smoothly and quickly remove recording paper that has been stored in a discharge tray by fast and high volume print processing. More specifically, it is possible to remove recording paper without stopping a print job, and discharge jams can be prevented.

FIG. 3 is a block diagram that shows the general configuration of a function control block of the image forming apparatus according to the embodiment of the invention.

The image forming apparatus 1 according to this embodiment is provided with a central control portion 30 configured with a central processing unit (CPU). Connected to the central control portion 30 via a bus 30b are an image forming processing portion 31, the image reading portion 19, the facsimile communications portion 32, the data communications portion 33, an operating display portion 34, a discharge distribution setting means 35, the discharge destination switching portion 51, the tray position control portion 52, a recording paper removal detection portion 57, and the like, and these are configured to perform, in cooperation with each other, computer control of the functions of the image forming apparatus 1.

A computer program necessary when each portion (the image forming processing portion 31, the image reading portion 19, the facsimile communications portion 32, the data communications portion 33, the operating display portion 34, the discharge distribution setting means 35, the discharge destination switching portion 51, the tray position control portion 52, the recording paper removal detection portion 57, and the like) executes the respective functions is installed in advance in a form that can be controlled by the central control portion 30. For example, the central control portion 30 can be provided with a program memory (not shown), and the necessary program can be installed in the program memory.

The image forming processing portion 31 is configured to control an image forming mechanism portion (including the exposing unit 11, the development unit 12, the photosensitive body 13, the charging unit 14, the cleaner unit 15, the fixing unit 16, and the like) that forms an image on recording paper, the image corresponding to image data acquired by the image reading portion 19, the facsimile communications portion 32, or the data communications portion 33; and a paper feed portion (the paper feed cassette 18 and the LCC 18a); or the like.

It is preferable to adopt a configuration in which the image reading portion 19 acquires image data as an ordinary copy machine (a copier), the facsimile communications portion 32 acquires image data via a public communications line (not shown) as a phototelegraphic machine (a facsimile machine), and the data communications portion 33 acquires image data via a LAN (not shown) as a printing machine (a printer).

Accordingly, the image forming apparatus 1 is configured to function (operate) as a copier based on an instruction (a print request) input by a user from the operating display portion 34, to function (operate) as a facsimile machine based on a communication (print request) received in the facsimile communications portion 32, or to function (operate) as a printer based on a communication (print request) received in the data communications portion 33.

That is, the image forming apparatus 1 is configured to execute a sequence of image forming (print processing and discharge processing) for processing function modes as embodiments that process a print request corresponding to each of a copy machine (a copier), a printing machine (a printer), and a phototelegraphic machine (a facsimile machine).

The operating display portion 34 is configured with a display-type tablet that can be used as both a display portion and an operating portion when the image forming apparatus 1 is operated as a copier. Accordingly, due to the central control portion 30 controlling the corresponding portions based on an instruction input to the operating display portion 34, the copy machine function of the image forming apparatus 1 is executed. Also note that the operating display portion 34 is disposed in the front upper face of the image forming apparatus 1, in consideration of operability (not shown).

The discharge distribution setting means 35 sets which of the first discharge tray 55 and the second discharge tray 56 that recording paper will be discharged to, and how many sheets of recording paper to distribute, based on an input (instruction) to the operating display portion 34. More specifically, the discharge distribution setting means 35 sets a distribution division for the recording paper discharged to each discharge tray. Also note that, for example, the distribution division can be prescribed with the discharge distribution destination and the number of sheets to be distributed to the discharge distribution destination.

Also, the discharge distribution setting means 35 is configured to discharge recording paper to the discharge unit 50 (the discharge destination switching portion 51 and the tray position control portion 52) based on the distribution division that is set. More specifically, the discharge distribution setting means 35 has a function to distribute recording paper to each discharge tray (the first discharge tray 55 and the second discharge tray 56) based on a number of sheets to be distributed that has been assigned in advance to the discharge distribution destination, by setting a distribution division for the number of sheets of recording paper to be discharged in response to a print request (the number of sheets in the print request).

Accordingly, in the image forming apparatus 1, it is possible to adjust (set, select) recording paper to be discharged in a large quantity to the discharge trays (the first discharge tray 55 and the second discharge tray 56) to a number of distributed sheets that a user can easily process, and thus it becomes possible to smoothly remove recording paper that has been stored in each discharge tray by fast and high volume print processing.

The discharge destination switching portion 51 controls switching of the discharge destination switching claw 51a (see FIGS. 2A and 2B) according to an instruction from the discharge distribution setting means 35 based on the number of distributed sheets of recording paper, in order to control setting of the recording paper discharge destination to either of the first discharge tray 55 and the second discharge tray 56.

The tray position control portion 52 is configured to appropriately adjust the positions of the first discharge tray 55 and the second discharge tray 56 according to the switching state of the discharge destination (see FIGS. 2A and 2B). That is, when discharge of recording paper to the first discharge tray 55 ends, and the discharge destination is switched from the first discharge tray 55 to the second discharge tray 56 so that recording paper is being discharged to the second discharge tray 56, by moving the position of the first discharge tray 55 upward, in a state in which discharge of recording paper to the second discharge tray 56 has ended, it is possible to easily remove recording paper from the second discharge tray 56. Also, it is preferable to adopt an embodiment in which the movement of the first discharge tray 55 is performed after removal of discharged paper from the first discharge tray 55 has been detected by the recording paper removal detection portion 57.

In the recording paper removal detection portion 57, a first detector 58 that detects removal of recording paper discharged to the first discharge tray 55, and a second detector 59 that detects removal of recording paper discharged to the second discharge tray 56, are connected. The recording paper removal detection portion 57 controls the operation of the first detector 58 and the second detector 59, and transmits the detection results to the central control portion 30. As the first detector 58 and the second detector 59, for example, it is possible to apply a weight sensor or other mechanical sensor.

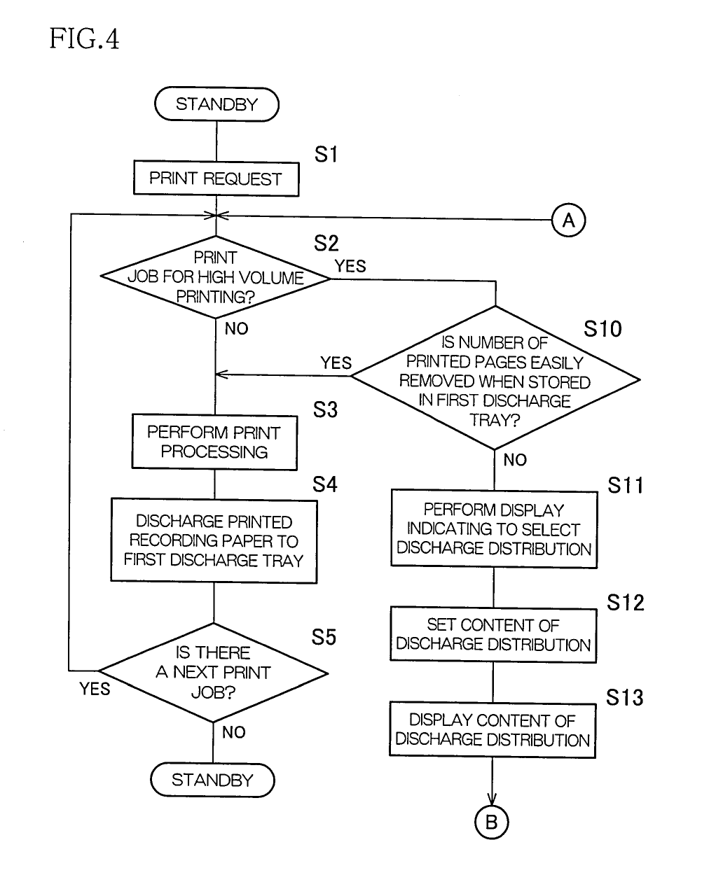

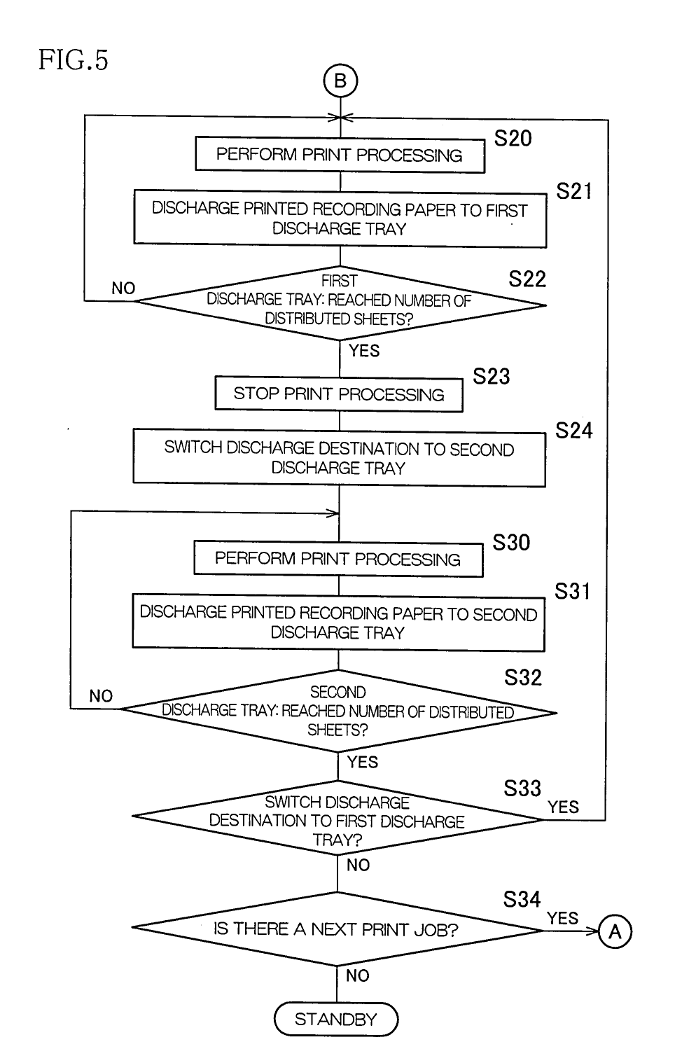

FIGS. 4 and 5 are flowcharts that show an example of the flow of processing in the image forming apparatus according to the embodiment of the invention.

The image forming apparatus according to this embodiment is configured to control and execute the below flow of processing using the central control portion 30 and each portion (the image forming processing portion 31, the image reading portion 19, the facsimile communications portion 32, the data communications portion 33, the operating display portion 34, the discharge distribution setting means 35, the discharge destination switching portion 51, the tray position control portion 52, and the like). Also note that it is not necessary to configure the discharge distribution setting means 35 using hardware, and for example, the discharge distribution setting means 35 is realized with a computer program.

Step S1:

The image forming apparatus 1 receives a print request. Included in the print request (print job) is, for example, input of a setting of the number of sheets to be printed when the image forming apparatus 1 functions as a copy machine (copier), and the like. After the print request is received, processing advances to Step S2.

When, for example, the image forming apparatus 1 operates as a copy machine, the print request is specified with input from the operating display portion 34. Also note that the print job is not limited to a print job in the case of a copy machine; this description also applies to a print job in the case of a facsimile machine or a printer.

Step S2:

A judgment is made of whether the print job that has been input is for high volume printing. High volume printing, for example, means a print request that exceeds the storage capacity of the first discharge tray 55 or the second discharge tray 56. Accordingly, when the first discharge tray 55 and the second discharge tray 56 each have a storage capacity of 1000 sheets, it is judged as high volume printing in the case where the print request is for 1800 sheets.

When the print job is not for high volume printing (Step S2: NO), processing advances to Step S3. When the print job is for high volume printing (Step S2: YES), processing advances to Step S10. The judgment of whether or not the print job is for high volume printing, for example, can be executed by the discharge distribution setting means 35.

Step S3:

Because the print job is not for high volume printing, ordinary print processing is executed by the image forming processing portion 31, and the processing advances to Step S4.

Step S4:

Because ordinary print processing is performed, printed recording paper (discharged paper) is discharged to the first discharge tray 55, and the processing advances to Step S5. Also note that the discharge destination switching portion 51 and the tray position control portion 52 are configured to maintain predetermined positions (ordinary positions) compatible with ordinary print processing.

Step S5:

A judgment is made of whether or not there is a next print job. When there is not a next print job, the flow of processing ends there as a standby state. When there is a next print job, the processing returns to Step S2. Also note that the judgment of whether or not there is a next print job, for example, can be executed by the central control portion 30.

Step S10:

A judgment is made of whether the number of sheets to be printed (the number of sheets in the print request) will be easily removed, assuming that the discharged recording paper is stored in the first discharge tray 55. When removal of the discharged recording paper is easy (Step S10: YES), the processing advances to Step S3. When removal of the discharged recording paper is not easy (Step S10: NO), the processing advances to Step S11. Also note that the judgment of whether or not removal of the discharged recording paper will be easy, for example, can be executed by the discharge distribution setting means 35.

The standard for the judgment of whether or not removal is easy, for example, can be set according to the removal ability of a user (for example, removal ability determined by physical strength). Alternatively, the standard can be set in advance in the image forming apparatus 1, using the average ability of users as the standard.

When, for example, the storage capacity of a discharge tray is 1000 sheets, for recording paper with a thickness of one sheet of 100 microns, 1000 sheets has a thickness of approximately slightly more than 10 cm, so it is not realistic to remove 1000 sheets at once. Therefore, for example, it is possible to set the judgment standard as 600 sheets, which is slightly more than half of the storage capacity.

Step S11:

Because removal of the discharged recording paper is not easy, a display is shown that prompts to select a discharge distribution that will distribute and discharge the printed recording paper to each discharge tray. The display is shown, for example, using the operating display portion 34. After the display is shown, the processing advances to Step S12.

The display prompting to select a discharge distribution, for example, can be a message stating, “A large number of sheets will be discharged. Sheets will be discharged divided among the discharge trays. Please enter the number of sheets to discharge to the first discharge tray and the second discharge tray.” The instruction causing the operating display portion 34 to display such a “message”, for example, can be output from the discharge distribution setting means 35.

Accordingly, when 600 sheets is set as the judgment standard, the “message” will be displayed when the number of sheets to be printed is 900 sheets.

Step S12:

The content of the discharge distribution (the distribution division of recording paper to be discharged) is, for example, set by the discharge distribution setting means 35. This setting may be selected by a user, or several forms of discharge distributions may be provided in advance in the image forming apparatus 1, with the setting selected therefrom. The “distribution division”, for example, can be prescribed with “the discharge distribution destination and the number of discharged sheets (number of distributed sheets) assigned in advance to that discharge distribution destination.”

The number of discharged sheets set with the distribution division is set to a number of sheets (number of distributed sheets) that is less than the storage capacity of the discharge tray, and the discharge tray is switched at a number of distributed sheets that is less than the storage capacity of the discharge tray, so it is possible to set a number of distributed sheets that the user can easily remove, and thus recording paper discharged to the discharge tray can easily be removed.

With the setting of the “content of the discharge distribution”, for example, a selection is made of setting the (content of the) number of discharged sheets based on either of the “number of discharged sheets” and the “number of discharged sets”.

When the number of distributed sheets is set based on the number of discharged sheets, for example, by setting in the manner below, it is possible to adopt a configuration in which the discharge distribution destination is selected and switched according to the number of distributed sheets.

For example, when the storage capacity of the first discharge tray 55 and the second discharge tray 56 together is 1000 sheets, for a print request of 1600 sheets, a distribution division (number of distributed pages) that respectively discharges 800 sheets to the first discharge tray 55 and 800 sheets to the second discharge tray 56 can be set. A configuration may also be adopted in which a user is caused to input a numerical value of two groups of 800 sheets (distribution division (number of distributed pages)).

Alternatively, a configuration may be adopted in which a standard value is set in advance in the image forming apparatus 1, and the user is caused to make a setting relative to the standard value. For example, in this state the storage capacity of the first discharge tray 55 is exceeded, and the excess amount can be stored in the second discharge tray 56 (where the print request is for more than or equal to 1000 sheets and less than 2000 sheets), so a program can be set and installed in advance that, as much as possible, divides into two equal halves.

Also, in the case of user for which removal of 800 sheets is difficult, for example, a configuration may be adopted in which the user is caused to input a distribution division (number of distributed sheets) of four groups of 400 sheets. That is, removal is performed in the manner of “400 sheets discharged to the first discharge tray 55→400 sheets discharged to the second discharge tray 56 and 400 sheets removed from the first discharge tray 55→400 sheets discharged to the first discharge tray 55 and 400 sheets removed from the second discharge tray 56→400 sheets discharged to the second discharge tray 56 and 400 sheets removed from the first discharge tray 55→400 sheets removed from the second discharge tray 56.” A configuration may also be adopted in which the user is caused to input a numerical value of four groups of 400 sheets (distribution division (number of distributed pages)).

Alternatively, a configuration may be adopted in which a standard value is set in advance in the image forming apparatus 1, and the user is caused to make a setting relative to the standard value. For example, it is possible to set 600 sheets as the maximum value for the number of sheets discharged to the first discharge tray 55 and the second discharge tray 56 when setting the discharge distribution, and to set and install a program that as much as possible evenly divides a print request that exceeds 1200 sheets. At this time, for example, 400 sheets is a number of sheets that can be used to evenly distribute 1600 sheets in groups of less than or equal to 600 sheets.

Removal of 400 sheets of recording paper can ordinarily be performed by any sort of user, so when the discharge trays (the first discharge tray 55 and the second discharge tray 56) are in a switched state, it is possible to quickly remove recording paper from the other discharge tray, and so it is possible to effectively make use of the high speed printing function.

Further, instead of dividing the discharged paper into four groups of 400 sheets, it is possible to adopt a combination in the manner of “500 sheets (first instance of the first discharge tray 55)→300 sheets (first instance of the second discharge tray 56)→500 sheets (second instance of the first discharge tray 55)→300 sheets (second instance of the second discharge tray 56).” By reducing the number of sheets of recording paper in the second discharge tray 56, from which recording paper is difficult to remove in comparison to the first discharge tray 55, it is possible to easily and quickly remove recording paper from the second discharge tray 56.

In this step of setting the content of the discharge distribution, the discharge destination is switched at a number of distributed sheets that is less than the storage capacity of each discharge tray, so it is possible to set an embodiment in which the discharge distribution destination is selected and switched according to the total number of discharged sheets. Also, when performing that setting, it is preferable that the image forming apparatus 1 presents a standard value, and to adopt an interactive program with which a user can appropriately respond to that standard value. The standard value used herein, for example, can be output to and displayed in the operating display portion 34 by the discharge distribution setting means 35.

Also, when the number of distributed sheets is set based on the number of discharged sets, for example, by processing in the manner below, it is possible to adopt a configuration in which the discharge distribution destination is selected and switched according to the number of distributed sheets.

For example, when the storage capacity of the first discharge tray 55 and the second discharge tray 56 together is 1000 sheets, for a print request for five sets with 300 sheets per set, that is, for a total of 1500 sheets, it is possible to set a distribution division (number of distributed sheets) that respectively discharges three sets (900 sheets) to the first discharge tray 55 and two sets (600 sheets) to the second discharge tray 56.

More specifically, it is possible to adopt a configuration in which the distribution division is set by assigning the distribution division destination and the number of distributed pages corresponding to the number of discharged sets, and the discharge distribution destination is switched at a number of distributed pages that is less than the storage capacity of the discharge tray. Thus, there is no risk of a problematic discharge as in the conventional technology, in which, for example, the fourth set is divided among the first discharge tray (901st sheet to 1000th sheet) and the second discharge tray (1001st sheet to 1200th sheet).

Also, for a print request for five sets with 300 sheets per set, in the case of a user for which removal of 900 sheets is difficult, for example, a configuration may be adopted in which five sets are removed in a distribution division (number of distributed sheets) of three groups. That is, removal is performed in the manner of “two sets (two sets, 600 sheets to the first discharge tray 55)→two sets (two sets, 600 sheets to the second discharge tray 56)→one set (one set, 300 sheets to the first discharge tray 55)”.

As described above, it is possible to set the content of the discharge distribution with a standard number of sheets or with a standard number of sets, and in addition, it is preferable to adopt a configuration in which the number of distributed sheets is set based on the job and the processing function mode.

For example, it is possible to set a distribution division (number of distributed sheets) in which a discharge tray is assigned to each job by applying the first discharge tray 55 to a print request (first job) from a first user and applying the second discharge tray 56 to a print request (second job) from a second user. Note that switching of the discharge distribution destination at a number of distributed sheets that is less than the storage capacity of the discharge tray is the same as in the examples described above.

With this configuration, it is possible to maintain the association between a job and recording paper discharged according to the discharge tray, so there is no risk that recording paper for each job will be mixed between jobs.

Here, by way of example, a description is given in which the jobs are divided according to the user (the first user and the second user), but of course it is also possible to make divisions according to different unit information with the same user (discharging document A to the first discharge tray 55, and discharging document B to the second discharge tray 56).

Also, in the case of a number of distributed sheets according to the processing function mode, for example, it is possible to set a distribution division (number of distributed sheets) in which a discharge tray is assigned to each processing function mode, corresponding to the copy machine function (copier), the printing machine function (printer), and the telephotographic machine function (facsimile machine) provided by the image forming apparatus 1. Note that switching of the discharge distribution destination at a number of distributed sheets that is less than the storage capacity of the discharge tray is the same as in the examples described above.

With this configuration, it is possible to maintain the association between discharged recording paper and the processing function mode, so there is no risk that recording paper for each processing function mode will be mixed between processing function modes.

Step S13:

In order to confirm the content of the discharge distribution (distribution division (discharge distribution destination and number of distributed sheets)) set in Step S12, the content of the discharge distribution is displayed in the operating display portion 34. In an example display at this time, a format can be adopted in which, for example, “tray name” and “number of distributed sheets” are set and listed in the order of discharge. By displaying the content of the discharge distribution, the content of the discharge distribution (number of distributed sheets) can be easily understood and accurately comprehended.

For example, in the final example of performing discharge distribution of 1600 sheets described above, it is possible to show a display such as “Discharge will be distributed in the following manner. Execute print processing after confirmation.” and “1: first discharge tray=500 sheets, 2: second discharge tray=300 sheets, 3: first discharge tray=500 sheets, 4: second discharge tray=300 sheets.”

Steps S20 and S21

After confirming the content of the distribution division (discharge distribution destination and number of distributed sheets)(Step S13), print processing is executed (Step S20). The printed recording paper is first discharged to the first discharge tray 55 (Step S21). Also note that it is possible to count the number of sheets discharged to the first discharge tray 55 with an appropriate counting means.

Step S22:

The recording paper discharged to the first discharge tray 55 is confirmed (the number of discharged sheets counted with the counting means is confirmed), and a judgment is made of whether or not the number of sheets discharged to the first discharge tray 55 has reached the number of distributed sheets. The judgment of whether or not the number of discharged sheets has reached the number of distributed sheets can be executed by storing the number of distributed sheets to be distributed and discharged to the first discharge tray 55 in, for example, a suitable temporary storage memory (not shown), and comparing to the number of discharged sheets counted for the first discharge tray 55.

When the number of sheets discharged to the first discharge tray 55 has not reached the number of distributed sheets (Step S22: NO), the processing returns to Step S20. When the number of sheets discharged to the first discharge tray 55 has reached the number of distributed sheets (Step S22: YES), the processing advances to Step S23.

Step S23:

Because the predetermined number of distributed sheets have been discharged to the first discharge tray 55, print processing is temporarily stopped, and the processing advances to Step S24. By temporarily stopping print processing, it is possible to easily and reliably perform discharge distribution and remove recording paper.

Step S24:

In a state with print processing temporarily stopped, the discharge destination is switched from the first discharge tray 55 to the second discharge tray 56 by the discharge destination switching portion 51. Also, a display indicating that the discharge destination has been switched to the second discharge tray 56 is shown in the operating display portion 34. By indicating that the discharge destination has been switched, the user can remove recording paper from the first discharge tray 55 in a reliable and stable state. At this time, as described above, it is possible to change the position of the first discharge tray 55 using the tray position control portion 52.

Steps S30 and S31

After the discharge destination has been switched from the first discharge tray 55 to the second discharge tray 56 (Step S24), print processing is executed (resumed)(Step S30). The printed recording paper is discharged to the second discharge tray 56, which is the discharge distribution destination to which a switch has been made (Step S31). Also note that it is possible to count the number of sheets discharged to the second discharge tray 56 with an appropriate counting means.

It is preferable to adopt a configuration in which when discharge of recording paper to the first discharge tray 55 as a prior discharge destination ends, and the discharge destination is switched to the second discharge tray 56 as a subsequent discharge destination, a removal request notification signal is generated that causes recording paper discharged to the first discharge tray 55 (Step S21) to be removed to outside during Step S30 (to Step S32).

Also, generating the recording paper removal request notification signal, for example, can be a display in the operating display portion 34, emission of a warning tone from a sound-emitting means (not shown), or the like, and thus it is possible to easily and reliably prevent discharge jams accompanying high speed discharge.

With this configuration, it is possible to reliably remove recording paper that has been discharged to the first discharge tray 55 when recording paper is being discharged to the second discharge tray 56, so that without interruption, it is possible to continuously discharge recording paper to the first discharge tray 55 again after discharge of recording paper to the second discharge tray 56.

Step S32:

The recording paper discharged to the second discharge tray 56 is confirmed (the number of discharged sheets counted with the counting means is confirmed), and a judgment is made of whether or not the number of sheets discharged to the second discharge tray 56 has reached the number of distributed sheets. The judgment of whether or not the number of discharged sheets has reached the number of distributed sheets can be executed by storing the number of distributed sheets to be distributed and discharged to the second discharge tray 56 in, for example, a suitable temporary storage memory (not shown), and comparing to the number of discharged sheets counted for the second discharge tray 56.

When the number of sheets discharged to the second discharge tray 56 has not reached the number of distributed sheets (Step S32: NO), the processing returns to Step S30. When the number of sheets discharged to the second discharge tray 56 has reached the number of distributed sheets (Step S32: YES), the processing advances to Step S33.

Step S33:

A judgment is made of whether or not to again switch the discharge destination to the first discharge tray 55. When, for example, the distribution division is three groups or more, it is necessary to discharge recording paper to the first discharge tray 55. When the distribution division is set as three groups or more (Step S33: YES), the processing returns to Step S20. Note that when returning to Step S20, print processing is stopped, same as in Step S23. When the distribution division is set as two groups (Step S33: NO), the processing advances to Step S34.

It is preferable to adopt a configuration in which, when returning from Step S33 to Step S20, or when advancing from Step S33 to Step S34, the recording paper removal detection portion 57 detects whether or not the discharged recording paper has been removed from the first discharge tray 55 or the second discharge tray 56.

That is, a configuration is adopted in which the discharge unit 50 is provided with the first detector 58 that detects removal of recording paper that has been discharged to the first discharge tray 55, and the second detector 59 that detects removal of recording paper that has been discharged to the second discharge tray 56, and subsequent print processing (discharge of recording paper) continues when removal of recording paper from the first discharge tray 55 or the second discharge tray 56 has been detected.

More specifically, a configuration is adopted in which discharge of recording paper to the first discharge tray 55 continues when removal of recording paper from the first discharge tray 55 has been detected, and discharge of recording paper to the second discharge tray 56 continues when removal of recording paper from the second discharge tray 56 has been detected.

For example, when “discharge of recording paper to the first discharge tray 55→discharge of recording paper to the second discharge tray 56”, in a state in which removal of recording paper discharged to the first discharge tray 55 has not been detected, subsequent continuous discharge of recording paper to the first discharge tray 55 is not executed. When “discharge of recording paper to the first discharge tray 55→discharge of recording paper to the second discharge tray 56→discharge of recording paper to the first discharge tray 55” (discharge of recording paper in three or more groups by the distribution division), and again discharging recording paper to the first discharge tray 55 (Steps S20 through S22), in a state in which removal of recording paper discharged to the second discharge tray 56 has not been detected, subsequent continuous discharge of recording paper to the second discharge tray 56 is not executed.

With this configuration, subsequent discharge continues after confirming removal of recording paper from each discharge tray, so it is possible to reliably prevent discharge jams.

Also, it is preferable to adopt a configuration in which, when discharge distribution has been performed, and removal of recording paper from the first discharge tray 55 or the second discharge tray 56 has not been detected, subsequent print processing is stopped. With this configuration, when removal of recording paper from each discharge tray cannot be confirmed, subsequent print processing (discharge) is stopped, so it is possible to reliably prevent discharge jams.

It is preferable to adopt a configuration in which, when the number of discharged sheets is large, and after discharge of recording paper to the first discharge tray 55 and the second discharge tray 56, discharge of recording paper to the second discharge tray 56 as a prior discharge destination ends and the discharge destination is again switched to the first discharge tray 55 as a subsequent discharge destination (Step S33: YES), a removal request notification signal is generated that causes recording paper discharged to the second discharge tray 56 (Step S31) to be removed to outside during subsequent Step S20 (to Step S22).

Also, generating the recording paper removal request notification signal, can be executed with the embodiment described above (Steps S30 and S31), and easily and reliably prevent discharge jams accompanying high speed discharge.

With this configuration, it is possible to remove recording paper that has been discharged to the second discharge tray 56 when recording paper is being discharged to the first discharge tray 55, so that without interruption, it is possible to continuously discharge recording paper to the second discharge tray 56 after discharge of recording paper to the first discharge tray 55.

Step S34:

Step S34 corresponds in the same manner as Step S5.

The present invention may be embodied in various other forms without departing from the gist or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. An image forming apparatus comprising a discharge unit that has a plurality of discharge trays including a first discharge tray and a second discharge tray as discharge distribution destinations, and that discharges printed recording paper to the discharge trays; wherein
according to distribution division settings for the recording paper that is discharged respectively to the first discharge tray and the second discharge tray, the discharge destination is switched from the first discharge tray to the second discharge tray at a number of distributed sheets of recording paper discharged to the first discharge tray that is less than the storage capacity of the first discharge tray.

2. The image forming apparatus according to claim 1, further comprising a discharge distribution setting portion for setting the distribution division.

3. The image forming apparatus according to claim 1, wherein the distribution division is set based on a number of discharge sheets.

4. The image forming apparatus according to claim 1, wherein the distribution division is set based on a number of discharged sets.

5. The image forming apparatus according to claim 1, wherein the distribution division is set based on a job.

6. The image forming apparatus according to claim 1, wherein the distribution division is set based on a processing function mode.

7. The image forming apparatus according to claim 1, wherein when discharge of recording paper to the first discharge tray used as a prior discharge destination ends and then the discharge destination is switched to the second discharge tray used as a subsequent discharge destination, a removal request notification signal is generated to cause the recording paper discharged to the first discharge tray to be removed to outside.

8. The image forming apparatus according to claim 1, wherein when discharge of recording paper to the second discharge tray used as a prior discharge destination ends and then the discharge destination is switched to the first discharge tray used as a subsequent discharge destination, a removal request notification signal is generated to cause the recording paper discharged to the second discharge tray to be removed to outside.

9. The image forming apparatus according to claim 1, further comprising:
a first removal detector that detects removal of recording paper that has been discharged to the first discharge tray; and
a second removal detector that detects removal of recording paper that has been discharged to the second discharge tray; wherein
when removal of recording paper from the first discharge tray has been detected, subsequent discharge of recording paper to the first discharge tray continues, and when removal of recording paper from the second discharge tray has been detected, subsequent discharge of recording paper to the second discharge tray continues.

10. The image forming apparatus according to claim 1, when removal of recording paper from the first discharge tray or the second discharge tray is not detected, subsequent print processing is stopped.

11. A method for switching a discharge tray in an image forming apparatus that comprises a plurality of discharge trays including a first discharge tray and a second discharge tray as discharge distribution destinations, and that discharges printed recording paper to the discharge trays, the method comprising:
setting a distribution division of recording paper to be discharged respectively to the first discharge tray and the second discharge tray; and
according to the distribution division that has been set, switching the discharge destination from the first discharge tray to the second discharge tray at a number of distributed sheets of recording paper discharged to the first discharge tray that is less than the storage capacity of the first discharge tray.
